(19) United States
(12) Patent Application Publication
(10) Pub. No.: US 2009/0307633 A1
(43) Pub. Date: Dec. 10, 2009

(54) Acceleration navigation of media device displays

(75) Inventors: Allen P. Haughay, JR., San Jose, CA (US); Alan Cannistraro, San Francisco, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/215,475

(22) Filed: Jun. 27, 2008

Related U.S. Application Data
(60) Provisional application No. 61/059,692, filed on Jun. 6, 2008.

(51) Int. Cl. G06F 3/048

(52) U.S. Cl. 715/841

(57) ABSTRACT

Some embodiments of the invention are directed to, among other things, systems, computer readable media, methods and any other means for navigating a menu hierarchy of a handheld electrical device and/or options within a menu display. The device can present each display on, e.g., an integrated display screen. In response to the device being physically moved, circuitry of the device can receive acceleration data generated by one or more accelerometers. The circuitry can be configured to respond to the acceleration data by generating an acceleration vector, storing the data and/or presenting another display. The new display can be, for example, another menu in the menu hierarchy or the same menu with a different option highlighted.

### CROSS-REFERENCE TO RELATED APPLICATION

This application claims priority to Haughay et al., U.S. Provisional Patent Application No. 61/059,692, filed Jun. 6, 2008, entitled “Acceleration Navigation of Media Device Displays,” the entirety of which is incorporated herein by reference.

### FIELD OF THE INVENTION

This relates to electrical devices that include a motion-detecting component. More specifically, this relates to handheld media devices that navigate interactive menu displays and menu hierarchies in response to various physical movements.

### BACKGROUND OF THE INVENTION

Portable and handheld electrical devices are a staple of modern society. Every day, millions of people use laptop computers, cellular telephones, digital music players and personal data assistants (PDAs). As technology and innovation progress, electrical devices become more portable and processors become faster. As a result devices have an increasing number of features and more complex menu systems, despite getting smaller, even handheld.

One handheld device was recently lauded as being revolutionary for successfully combining, among other things, a cellular phone, wireless internet connectivity, media player, and a touch screen. That device is Apple Inc.'s iPhone™. (Apple Inc. owns the iPhone™ trademark.) Although many of the features had been previously integrated in its larger brethren (some of which were portable but not handheld), the iPhone™ device was lauded as revolutionary, largely because Apple Inc. figured out how to integrate those features (in addition to others) in a handheld device.

Handheld devices can utilize a number of different means for receiving user inputs. For example, the iPhone™ includes a multi-touch display screen. Most other cellular telephones include a QWERTY keypad and/or number pad. Some devices, like BlackBerrys™, also include a scroll wheel and/or scroll ball. (BlackBerry™ is a service mark owned by Research In Motion Limited Corporation.) As yet another example, iPods™ include click wheels. (iPod™ is a trademark owned by Apple Inc.)

All of these components receive some sort of touch-based, physical stimulus that is converted to electrical data signals. The data signals can be used to control the functionality of the electrical device. For example, the data signals can cause the electrical device to make a telephone call, present an informational or media display, take a picture, and/or perform any other function that the device is configured to allow a user to control.

For example, a handheld electrical device can present displays that include text, images, video and/or any other type of information. Multi-touch display screens are frequently configured to display virtual buttons and other types of options to the user. The user may select a virtual button by tapping the multi-touch display screen where the virtual button is being displayed. The locations, shapes and sizes of virtual buttons, unlike physical buttons, can be dynamic and change as the user navigates through the menu system of the electrical device. This allows the same physical space to represent different buttons at different times. Multi-touch display screens are discussed in more detail in commonly assigned U.S. Patent Publication No. US 2006/0097991, entitled “MULTIPOINT TOUCHSCREEN,” which is incorporated by reference herein in its entirety.

Some portable electrical devices also include other types of sensors that detect other types of physical stimuli. For example, the iPhone™ includes an ambient light sensor, proximity sensor and accelerometer. The ambient light sensor can be used to adjust the brightness of the multi-touch screen; the proximity sensor is used to prevent erroneous touch events during a telephone call; and the accelerometer is used for a number of reasons.

For example, accelerometers have been used to prevent damage to moving parts, like a spinning storage device. If a storage device is spinning when it is dropped to the floor, the storage device can be permanently damaged. To prevent such damage, an accelerometer can allow an electrical device to determine that it is falling to the floor and, in response, the electrical device can stop the movement of the storage device or any other component that is physically moving.

The present invention improves on the devices discussed above as well as on others.

### SUMMARY OF THE INVENTION

The present invention includes methods, systems, computer readable media and means for receiving and converting physical stimuli into electrical data signals. The physical stimuli can take any form, including an acceleration event, such as a flicking motion. The present invention can utilize an accelerometer to detect and measure the acceleration event, and even determine the direction and magnitude of the acceleration event. The direction and magnitude of the acceleration event are sometimes collectively referred to herein as the acceleration vector. The acceleration vector can be used by the invention to enable and provide acceleration navigation of a menu hierarchy and/or among selectable options within each menu's display.

In some embodiments of the present invention, one or more accelerometers can be used (sometimes in combination with other circuitry) to create the acceleration vector. The one or more accelerometers can each be single-axis or multi-axis. For example, two single-axis accelerometers or a single dual-axis accelerometer can be used to collectively detect movement in two directions. Similarly a three-axis accelerometer can be used to detect acceleration events in any of the three dimensions.

Some embodiments of the invention are directed to, among other things, systems, computer readable media, methods and any other means for navigating a menu hierarchy of a handheld electrical device and/or options within a menu display. The device can present each display on, e.g., an integrated display screen.

In response to the device being physically moved, circuitry of the device can receive acceleration data generated by one or more accelerometers. The circuitry can be configured to respond to the acceleration data by presenting a second display. The second display can be, for example, another menu in the menu hierarchy or the same menu with a different option highlighted. Highlighted, as used herein, includes any means or method for emphasizing one option in relation to another. Common forms of highlighting one or more options include, for example, a bolder font, a colored-in-area around the option, a line around the option, etc. A cover flow type of approach (using, e.g., album covers or other clip art) can also be used to highlight an option. Cover flow displays are show in connection with, e.g., FIG. 9 below and are is discussed in commonly assigned U.S. Patent Publication No. 2006/0066016, entitled “MEDIA MANAGER WITH INTEGRATED BROWSERS,” which is incorporated herein by reference in its entirety.

One or more of the selectable options included in the display can be a link to a target. The target can be another display, media file, device feature (e.g., play button, mute button, etc.), etc. The acceleration data generated by the accelerometers can represent, for example, a user's desire to select one or more of the options. The device can generate the options based on information, or metadata, associated with the options or the target. For example, the device can present information associated with one or more songs stored on the handheld electrical device and that information can be generated based on metadata associated with the songs. The songs and metadata can be, for example, downloaded from a remote server (such as the iTunes™ Store) or other device (such as a desktop or laptop computer), generated locally by the electrical device, or any combination thereof. (iTunes™ is a trademark owned by Apple Inc.)

The device's circuitry can be configured to analyze the acceleration data and determine a type of the acceleration event (e.g., flick, shake, tilt, spin, rotate, drop, etc.). In some instances, this can include determining a prevailing direction of the acceleration event. For example, a downward flick can have an upward recoil. The circuitry (and/or the software implemented thereon) can be configured to compensate for and/or disregard the upward recoil and determine that the prevailing direction of the flick was down. As such, the circuitry can be configured to determine the type movement (e.g., downward flick) that caused the acceleration event.

The circuitry can also be configured to determine a magnitude of the acceleration event. For example, one or more threshold values can be used to determine the magnitude of an acceleration event. The threshold values can be incrementally related, and be independent or dependent of each other in each of the three dimensions. The device can also generate an acceleration vector based on the prevailing direction and the magnitude of the acceleration event.

Some embodiments of the present invention can be configured to playback media files, in addition to implementing a menu hierarchy. The playback and other features relating to media files can also be controlled and/or adjusted in response to an acceleration event. For example, a number of up and down flick events (which may or may not have to occur within a predetermined period of time) can cause the device to shuffle or unshuffle a play list of songs stored on and/or generated by the device.

As mentioned above, some embodiments of the invention can also be used to navigate among options within a list, cover flow or any other type of display. For example, the device can present options associated with a number of songs. One of the songs can be highlighted. In response to receiving one or more acceleration events, a second song can be highlighted. The second song can be adjacent to the first song, or a number of other songs (or options) can be between the first and second songs. The magnitude, type, number and/or time of one or more flicks can effect how the device to scrolls through songs (or any other type of selectable option), the rate at which the songs are scrolled through (e.g., how many options are scrolled through at a time), and/or anything functionality provided by the device.

### SUMMARY OF THE DRAWINGS

The above and other features of the present invention, its nature and various advantages will be more apparent upon consideration of the following detailed description, taken in conjunction with the accompanying drawings, in which like reference characters refer to like parts throughout, and in which:

FIGS. 1-2 are exemplary systems in accordance with some embodiments of the present invention;

FIG. 3 shows a simplified schematic block diagram of an exemplary embodiment of circuitry in accordance with some embodiments of the present invention;

FIGS. 4-9 are exemplary displays that can be presented in accordance with some embodiments of the present invention; and

FIGS. 10-12 are a simplified logical flows of an exemplary modes of operation of circuitry in accordance with some embodiments of the present invention.

### DESCRIPTION OF THE INVENTION

Recent developments in technology allow smaller electrical devices to have increased functionality. For example, portable electrical devices now include a number of sensors, like proximity sensors, accelerometers, GPS locators, ambient light detectors, etc. But these sensors have, until recently, only been used for a very limited purposes. As devices get smaller and the devices' internal real estate becomes more valuable, the need and uses of even the smallest sensor are being reevaluated and means for utilizing them as much as possible are being researched. Much research and thought is being dedicated to these issues, and various approaches are being implemented.

For example, systems and methods for utilizing various sensors to automatically control the functionality (e.g., ringer volume, etc.) and mode of an electrical device are available. The electrical device can utilize a global positioning sensor and/or accelerometer to determine that the user is driving a motor vehicle and, in response, enter a car mode (that, e.g., disables the built in speaker and requires the use of a wireless headset). Automatically adjusting the functionality and operational modes of an electrical device in response to various sensor outputs is discussed further in commonly assigned U.S. patent application Ser. No. ______, entitled “EVENT-BASED MODES FOR ELECTRICAL DEVICES” (hereinafter referred to by its client docket no. “P4788US1”) and U.S. patent application Ser. No. ______, entitled “PERSONAL MEDIA DEVICE INPUT AND OUTPUT CONTROL BASED ON ASSOCIATED CONDITIONS” (hereinafter referred to by its client docket no. “P5355US1”), both of which are incorporated herein by reference in their entireties.

Despite the invention having the potential to be implemented by using a number of different sensors, the invention can just as easily be implemented with a single type of sensor, such as an accelerometer. As discussed above, accelerometers have traditionally been used in portable and handheld electrical devices to prevent damage to moving parts when the device falls to the ground. More recently, accelerometers have been used to determine the physical orientation (e.g., portrait or landscape) of a portable electrical devices (such as, the iPhone™). Using accelerometers to determine the physical orientation of a handheld device and, in response, adjusting the orientation of the display presented by the device is discussed further in commonly assigned U.S. patent application Ser. No. ______, entitled “PORTRAIT-LANDSCAPE ROTATION HEURISTICS FOR A PORTABLE MULTIFUNCTION DEVICE” (client docket no. “P4814US1”), which is incorporated herein by reference in its entirety.

Some additional benefits of accelerometers in portable devices have also been realized. For example, one or more accelerometers can be used to detect the turning, tilting, sliding, spinning and/or vibrating of the portable device. In response to the device being moved in any manners, the portable device can present or update information on a display screen. For example, when the device is moved while presenting a document, slide show or a webpage, the device can determine the direction and type of the movement and, in response, present the next page of the document, advance the slide show or scroll down the webpage. In this manner, one or more accelerometers can enable the device to present displays that appear to be affected by gravity and/or other acceleration forces.

Commonly assigned U.S. Patent Publication No. 2006/0017692, entitled “METHODS AND APPARATUS FOR OPERATING A PORTABLE DEVICE BASED ON AN ACCELEROMETER” (referred to herein as the '692 application), which is incorporated herein by reference in its entirety, discusses some examples of how one or more accelerometers can be used to present displays that appear to be (and, in some manners, are actually) effected by gravity or other acceleration forces. More specifically, in response to the accelerometer(s) detecting a movement of the portable device, the accelerometer can generate moving data that the device's circuitry can use to generate a moving vector (sometimes referred to in the '692 application as an acceleration vector). The moving vector, like all vectors, comprises a magnitude and direction. Software, firmware and/or circuitry can perform one or more actions based on the moving vector(s). The responsive actions can be user configurable, default system configurations and/or configured dynamically, automatically by the system (based on, e.g., a firmware update). In addition to turning a page of a document, the '692 application also includes the following acceleration navigation examples: playing a video game, navigating a map, moving around an image, activating/deactivating interfaces (including audio interfaces, wireless interfaces, video interfaces, etc.) of a portable device, reconfiguring interfaces, playing multimedia content, controlling power management features, unlocking features of the device, recreating a trail of movements, compensating for movements of the device, and operating a component of the device.

The present invention improves on the teachings of the '692 application by providing systems, methods, computer readable media and other means for navigating selectable options of a display as well as navigating a menu hierarchy implemented by an electrical device based at least partially on the movements of the electrical device.

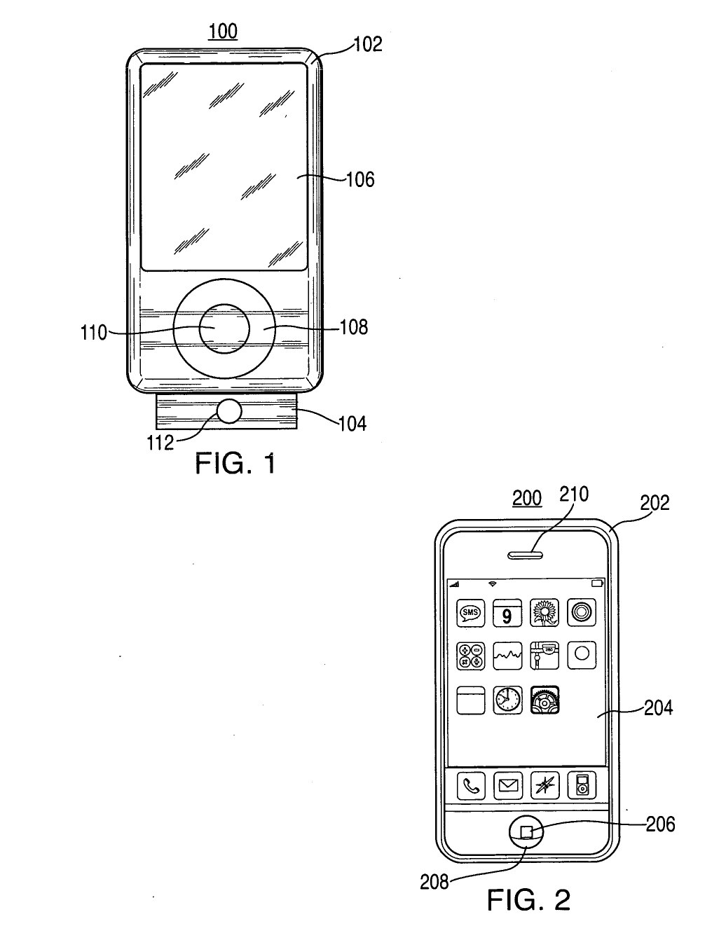

FIG. 1 shows system 100, which can be operated in accordance with some embodiments of the present invention. System 100 includes handheld device 102 and accessory device 104.

Handheld device 102 can be used to play media (e.g., music, images, video, etc.), generate media (e.g., take pictures, record audio, etc.), access the Internet, take notes, organize appointments, and/or perform any other function. One or more additional accessory devices (not shown), such as headphones, can also be included in system 100. Handheld device 102 is illustrated as an iPod™, but one skilled in the art will appreciate that handheld device 102 can be any type of electrical device.

Handheld device 102 includes display component 106. As illustrated in FIG. 1, display component 106 can be a display screen that is integrated into handheld device 102. Display component 106, like any other component discussed herein, does not have to be integrated into handheld device 102 and can be external to handheld device 102. For example, display component 106 can be a computer monitor, television screen, and/or any other graphical user interface, textual user interface, or combination thereof.

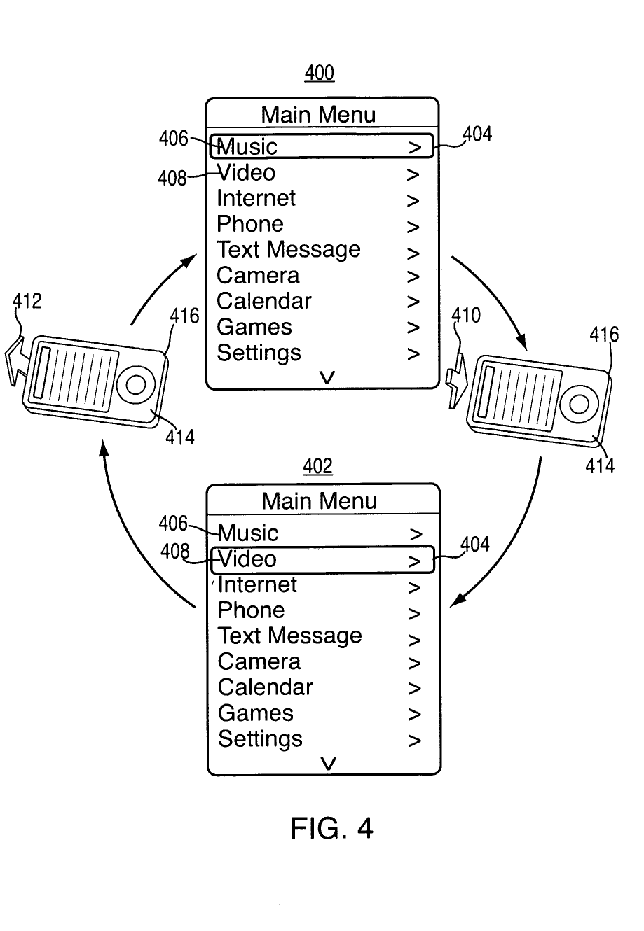

Display component 106 enables handheld device 102 to present displays to a user. The displays can include various types of information and selectable options. For example, a display can include media or information about media that is being played back or can be played back. The displays can also include information downloaded from the Internet, contact information, map information or any other type of information. The information can be interactive and responsive to user inputs. In addition, the displays presented by display component 106 can include selectable options that allow a user to navigate the menu hierarchy and utilize the features implemented by handheld device 102. Additional examples of displays are discussed below in connection with FIGS. 4-9.

User input component 108 is illustrated in FIG. 1 as a click wheel. User input component 108 (in combination with its driver circuitry, discussed below) can be used to convert one or more touch inputs into electrical signals, which can cause handheld device 102 to generate and execute one or more executable commands. The center portion of input component 108 can be button 110. Button 110 can be pressure sensitive, touch sensitive, a proximity sensor, and/or any other type of button or input component. For example, user input component 108 can be used to control handheld device 102, interact with the menu hierarchy implemented on handheld device 102, and/or instruct handheld device 102 to perform any function it is configured to perform.

One skilled in the art will appreciate that user input component 108 can be any type of user input device that receives a user input and, in response, facilitates the creation of one or more corresponding electrical signals. One skilled in the art will also appreciate that user input component 108 can be integrated into or located external to handheld device 102. For example, user input component 108 can also be, or include, at least one mouse, keyboard, trackball, slider bar, switch, button (such as button 110), number pad, dial, or any combination thereof.

Another example of a user interface component is a multi-touch display screen such as that discussed below in connection with, e.g., FIG. 2 and described in commonly assigned Westerman et al., U.S. Pat. No. 6,323,846, issued Nov. 27, 2001, entitled “Method and Apparatus for Integrating Manual Input,” which is incorporated by reference herein in its entirety. User input component 108 may emulate a rotary phone or a multi-button electrical device pad, which may be implemented on a touch screen or the combination of a click wheel or other user input device and a screen. A more detailed discussion of such a rotary phone interface may be found, for example, in McKillop et al., U.S. patent application Ser. No. 11/591,752, filed Nov. 1, 2006, entitled “Touch Pad with Symbols based on Mode,” which is incorporated by reference herein in its entirety.

Accessory device 104 is shown in FIG. 1 as being physically and electrically coupled to handheld device 102 via connector components (not shown) that are integrated into both accessory device 106 and handheld device 102. Accessory device 104 can, for example, enable and/or enhance the acceleration navigation functionality of handheld device 102. Accessory device 104 can include one or more accelerometers that can detect a flicking or other acceleration-related motion (e.g., shaking, spinning, tilting, turning upside down, sliding, etc.).

For example, handheld device 102 may not include an accelerometer, the appropriate driver circuitry and/or the software application necessary to enable acceleration navigation of the menu hierarchy implemented on handheld device 102. The components and/or software that is missing from handheld device 102, and is preventing acceleration navigation from being possible, can be included in accessory device 104. In such embodiments, when accessory device 104 is coupled to handheld device 102, the acceleration navigation can be enabled. Various types of acceleration navigation (e.g., flick navigation, tilt navigation, spin navigation, etc.), how it works and ways it can be used are discussed more below.

In some embodiments, handheld device 102 can include all of the necessary components and software for acceleration navigation, and provide acceleration navigation in the absence of accessory device 104. In such embodiments, accessory device 104 can be used to enhance the acceleration navigation functionality of handheld device 102. For example, accessory device 104 can be used to enhance the detection of, among other things, the types of flicks (quick flicks, slow flicks, rapid flicks, etc.), angles of tilt and direction of spins as well as additional directions of each (in, e.g., two or three dimensions).

Accessory device 104 can also include one or more buttons and/or other input components. For example, accessory device 104 is shown in FIG. 2 as including touchpad 112. Touchpad 112 can be any type of touch-sensitive area, such as a touchscreen or touchpad. A touchpad, unlike a touch screen, does not display a visual output. A laptop computer's mousepad is an example of one type of touchpad.

Button 110 and/or touchpad 112 can be used to perform any function, including an activation or deactivation function. For example, flick navigation of handheld device 102 can be disabled, unless button 110 and/or touchpad 112 is being depressed and/or touched. In this manner, the display may not change in response to handheld device 102 and/or accessory device 104 being erroneously flicked or moved around, and may only change when button 110 and/or touchpad 112 is depressed and/or touched and the device is being, e.g., flicked. Similarly, any other input component (or portion thereof) can act as a acceleration navigation activation (or deactivation) button. Systems and methods for using a touchpad to enable certain functionality is discussed in commonly assigned U.S. patent application Ser. No. ______, filed ______, entitled “Portrait-Landscape Rotation Heuristics for a Portable Multifunction Device” (hereinafter as “P4814US1”), which is incorporated herein by reference in its entirety.

In other embodiments, accessory device 106 can be electrically coupled to handheld device 102 wirelessly. Accessory device 104 can then act as a remote control and be used to wirelessly navigate and control handheld device 102. Handheld device 102 and accessory device 104 can exchange information using any protocol (such as, e.g., BlueTooth™) and can pair together automatically. Automatic BlueTooth™ pairing is discussed in more detail in commonly assigned Tang et al., U.S. patent application Ser. No. 11/823,923, filed Jun. 28, 2007, entitled “Apparatuses and Methods that Facilitate the Transfer of Power and Information Among Electrical Devices,” which is incorporated by reference herein in its entirety.

Accessory device 104 can operate automatically after successfully executing the proper handshaking protocols, in response to it being coupled to handheld device 102 or in response to one or more user input(s). For example, accessory device 104 may not have its own power supply or input components and only function when it is coupled to handheld device 102. As another example, specialized circuitry or applications (for example, flick navigation of handheld device 102's menu hierarchy) can be included in accessory device 104 and not in handheld device 102.

FIG. 2 shows computer system 200 which can also be used in accordance with the present invention. Computer system 200 includes electrical device 202, which is shown in FIG. 2 as an iPhone™. As such, electrical device 202 can function as, among other things, a portable media player, cellular telephone, personal organizer, web browser, and GPS device. One skilled in the art will appreciate that electrical device 202 can be any type of electrical device and be coupled to and used with any type of accessory device without departing from the spirit of the invention.

Electrical device 202 comprises user interface component 204. User interface component 204 is shown in FIG. 2 as a multi-touch screen that can function as both an integrated display screen (the same as or similar to display 106 described above) and an input device that can receive touch events. Multi-touch display screens are discussed in more detail in commonly assigned U.S. Patent Publication No. U.S. 2006 0097991, entitled “MULTIPOINT TOUCHSCREEN,” which is incorporated herein by reference in its entirely. Electrical device 202 can also include one or more other user interface components, such as button 206, which can be used to supplement user interface component 204.

Microphone 208 and audio output 210 are respective examples of other input and output components that can be integrated into electrical device 202 or any other device discussed herein. Microphone 208 is preferably a transducer that can capture analog audio signals and convert them into digital signals.

Audio output 210 is shown as being a speaker integrated into electrical device 202, but one skilled in the art will appreciate that audio output 210 may also comprise an external device (such as headphones not shown) and/or one or more connector(s) used to facilitate the playing back of audio content and/or the audio portion of video content.

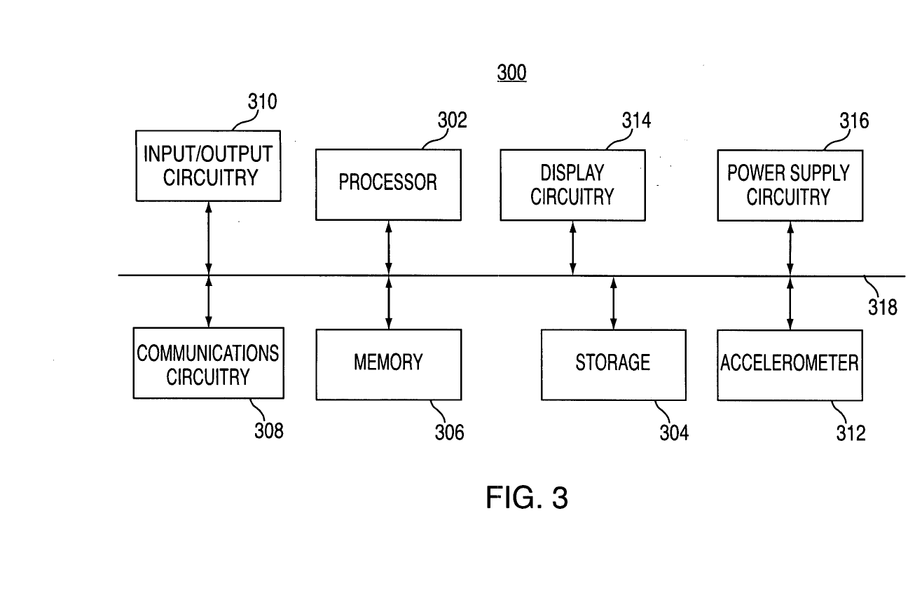

FIG. 3 illustrates a simplified schematic diagram of an illustrative electrical device or devices in accordance with some embodiments of the present invention. Electrical device 300 can be implemented in or as any type of electronic device or devices, such as, for example, handheld devices 102 and electrical device 202 discussed above.

Electrical device 300 can include control processor 302, storage 304, memory 306, communications circuitry 308, input/output circuitry 310, accelerometer 312, display circuitry 314 and/or power supply circuitry 316. In some embodiments, electrical device 300 can include more than one of each component, but for sake of simplicity, only one of each is shown in FIG. 3. In addition, one skilled in the art will appreciate that the functionality of certain components can be combined or omitted and that additional components, which are not shown in FIGS. 1-3, can be included in handheld device 102, accessory device 106, and/or electrical devices 202 and 300 or any other embodiment in accordance with the present invention.

Processor 302 can include, for example, any type of circuitry that can be configured to perform any function. Processor 302 may be used to, for example, run operating system applications, firmware applications, media playback applications, media editing applications, and/or any other application implemented on electrical device 300.

Storage 304 can be, for example, one or more storage mediums, including, a hard-drive, flash memory, other non-volatile memory, any other suitable type of storage component, or any combination thereof. Storage 304 may store, for example, media data (as, e.g., music, image and/or video files), application data (for, e.g., implementing functions on device 200), firmware, user preference information data (e.g., media playback preferences), lifestyle information data (e.g., food preferences), exercise information data (e.g., information obtained by exercise monitoring equipment), transaction information data (e.g., information such as credit card information), wireless connection information data (e.g., information that may enable electrical device 300 to establish a wireless connection), subscription information data (e.g., information that keeps track of podcasts or television shows or other media a user subscribes to), contact information data (e.g., telephone numbers and email addresses), calendar information data, any other suitable data, or any combination thereof.

Memory 306 can include cache memory, semi-permanent memory (such as RAM), and/or one or more different types of memory used for temporarily storing data. Memory 306 can also be used for storing data used to operate electrical device applications.

Communications circuitry 308 can permit device 300 to communicate with one or more servers or other devices using any suitable communications protocol. For example, communications circuitry 308 may support Wi-Fi (e.g., a 802.11 protocol), Ethernet, Bluetooth™ (which is a trademark owned by Bluetooth Sig, Inc.), high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 308 can also function, in some embodiments, as input/output circuitry 310 that allows device 300 to download and upload data.

Input/output circuitry 310 can convert as well as encode/decode, if necessary, analog, digital and/or any other type of signal (e.g., physical contact inputs (sometimes called touch events, from e.g., a multi-touch screen), physical movements (from, e.g., a mouse), analog audio signals, etc.) into digital data. Input/output circuitry 310 can also convert digital data into any other type of signal. The digital data can be provided to and received from processor 302, storage 304, memory 306, or any other component of electrical device 300. Although input/output circuitry 310 is illustrated in FIG. 3 as a single component of electrical device 300, a plurality of input/output circuitry can be included in electrical device 300. Input/output circuitry 310 can be used to interface with any input or output component, such as those discussed in connection with FIGS. 1 and 2. For example, electrical device 300 can include specialized input circuitry associated with, e.g., one or more microphones, cameras, proximity sensors, accelerometers, ambient light detectors, etc. Electrical device 300 can also include specialized output circuitry associated with output devices such as, for example, one or more speakers, other type of transducer, etc.

Display circuitry 314 is an example of a specific type of output circuitry. Display circuitry 314 can accept and/or generate data signals for presenting media information (textual and/or graphical) on a display screen. Some examples of displays that can be generated by display circuitry 314 are discussed below. Display circuitry 314 can include, for example, a coder/decoder (CODEC) to convert digital media data into analog signals. Display circuitry 314 also can include display driver circuitry and/or any other circuitry for driving a display screen. The display signals can be generated by, for example, processor 302 and/or display circuitry 314. In some embodiments, display circuitry 314, like any other component discussed herein, can be integrated into and/or external to electrical device 300.

Power supply 316 can provide power to the components of device 300. In some embodiments, power supply 316 can be coupled to a power grid (e.g., a wall outlet or automobile cigarette lighter). In some embodiments, power supply 316 can include one or more batteries for providing power to a portable electrical device. As another example, power supply 316 can be configured to generate power in a portable electrical device from a natural source (e.g., solar power using solar cells).

Bus 318 can provide one or more data transfer paths for transferring data to, from, and/or among control processor 302, storage 304, memory 306, communications circuitry 308, and any other component included in electrical device 300. Although bus 318 is shown as a single line in FIG. 3 to avoid unnecessarily overcomplicating the drawing, one skilled in the art will appreciate that bus 318 may comprise any number and type(s) of data paths (e.g., metallic, fiber optic, optical, etc.).

FIGS. 4-8 are depictions of representative interactive user interface displays according to some embodiments of the invention. More specifically, a processor (and/or other circuitry) can be configured to present the interactive user interface displays of FIGS. 4-8 on a display screen or other user interface component. It is important to note that the displays shown in FIGS. 4-8 have been engineered and designed to be optimized for providing advanced interactive functionality, despite the limitations of a relatively simple user input component or device, such as a click wheel or six button remote control.

Simple user input devices, though easy for users to use, limit how a user can navigate within a display and menu hierarchy. Moreover, multi-touch display screens, although very intuitive and simple to use, may require the use of two hands in certain applications—one to hold the device, the other to make selections by tapping the screen. Acceleration navigation, according to some embodiments of the invention, allow a user to use a multitouch or any other type of device with just one hand and/or without the need to see the display (when, e.g., flick patterns are used). Designing interactive displays as well as adapting new input components to previously designed displays is a more complicated process with unique technical problems, than simply implementing displays that are used with other, more intricate user input devices (such as a mouse and keyboard combination, cellular telephone keypad, standard remote control that often has 12 or more buttons, etc.).

FIG. 4 shows display 400 and display 402, which may be generated by, e.g., processor 302 and/or display circuitry 314. Displays 400 and 402 can be presented by, e.g., display component 106 or user interface 204. Like any display discussed herein, any electrical device can present display 400 or display 402 in response to, for example, data being generated by an input component (e.g., in response to the user selecting an input button (virtual or physical)), the electrical device being powered ON, an accessory device (such as, e.g., accessory device 104) being coupled to the electrical device, receiving a signal from a remote device (not shown), an automatic or preconfigured setting being triggering (alarm clock, etc.) and/or any other stimuli.

Displays 400 and 402 are Main Menu displays that have different options highlighted by highlight region 404. In display 400, music option 406 is highlighted. In display 402, video option 408 is highlighted. The device can move highlight region 404, as mentioned above, in response to a number of different inputs. For example, input data generated by a click wheel or multitouch interface can cause highlight region 404 to move up and down the list included in displays 400 and 402.

Acceleration navigation can also be used to navigate between displays 400 and 402. The detection of predominantly downward acceleration event can cause highlight region 404 to move down the list of options. The detection of a predominantly upward acceleration event can cause highlight region 404 to move up the list of options. Downward vector 410 and upward vector 412 represent acceleration vectors that are generated by, e.g., the circuitry of device 414. Device 414 can be any type of electrical device, including devices that function similar to or the same as handheld device 102 and/or electrical device 202 (discussed above).

In some embodiments, downward vector 410 and upward vector 412 represent an initial movement of device 414, caused by, for example, a centripetal acceleration vector. A centripetal acceleration vector has an inward direction along the radius of the circular motion and a magnitude related to the tangential speed and angular velocity of the movement of the accelerometer. Holding a device, such as device 414, by one end (e.g., near bottom edge 416) and making a flicking gesture, can cause the accelerometer(s) in device 414 to detect a centripetal acceleration vector. Downward vector 410 or upward vector 412 can also one or more accelerometers detecting a lateral, perpendicular and/or other acceleration vector(s), so long as the prevailing direction is down or up.

Downward vector 410 and/or upward vector 412 can be based on acceleration data generated by one or more accelerometers of device 414. For example, acceleration data can be generated in response to determining that the top of device 414 is moving in a rotational manner with respect to an axis parallel to bottom edge 416 of device 414. The data can include a magnitude and direction. This data can be used by, for example, the other circuitry of device 414. The accelerometer(s) and/or other circuitry of device 414 can generate, for example, downward navigational data or upward navigational data, based on vector 410 or vector 412, that can cause, for example, highlight region 404 to move among the options available to the user.

In some embodiments, when a number of data outputs are received from one or more accelerometers, device 414 can differentiate, for example, different types of acceleration-related movements (e.g., flick, slide, twist, spin, tilt, etc.), relative timing of each and the directions of each. Device 414 can base its response on, for example, the predominant motion or motions.

For example, the primary difference between downward vector 410 and upward vector 412 is the direction of the vector. Downward vector 410 is primarily directed towards the back of device 414 (assuming the front surface is the surface with the display screen). Upward vector 412 is primarily directed towards the front of device 414. The circuitry of device 414 can utilize any number of means to determine the predominant, or sometimes referred to herein as prevailing, direction of an acceleration event. For example, the predominant direction determination can be based on an average of all the detected vectors (e.g., up, down, left and right), the initial vector's direction, or by any other means.

Displays 400 and 402 can be presented by a display integrated into device 414. One skilled in the art will also appreciate that displays 400 and 402 can also be presented by a device remote from device 414 and/or any other electrical device, thereby allowing device 414 to function as a remote control. As such, device 414 can enable acceleration navigation among display 400, display 402 and/or any other displays, regardless of whether or not the displays are presented by device 414 and/or another device.

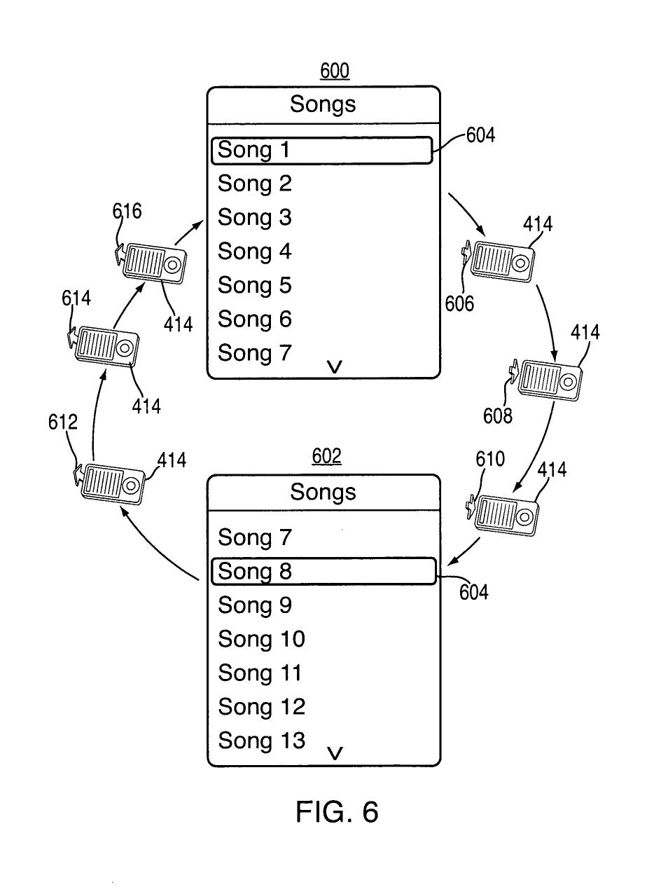

In some embodiments, the ability to detect the magnitude of a vector can cause device 414 to advance highlight region 404 more than one option, in response to detecting only one acceleration vector. For example, a sharp flick, which has a relatively large magnitude, can cause cursor 404 to scroll through eight items as shown in FIG. 6 (instead of one as shown in FIG. 4).

In addition to the magnitude, device 414 can also calculate a magnitude-to-time ratio of an acceleration movement or event. For example, a sharp, quick flick, which will be an acceleration event having a large magnitude-to-time ratio, can cause cursor 404 to advance rapidly through a number of options, even jump to the next group of options (e.g., five at a time, a category at a time, a letter at a time, etc.). In some embodiments, device 414 can present an overlay that appears on the display screen to cue the position within the media list and allow a large list to be scrolled through, e.g., a category at a time (such as by first letter). As another example, a gentle, slow flick (which is analogous to a tilt motion), which has a small magnitude-to-time ratio, can cause cursor 604 to move slowly down the list at a steady pace (e.g., one option at a time, after delaying for a short period of time, such as one second). As such, the magnitude-to-time ratio can be correlated to the amount of time and number of intermediate displays device 414 utilizes when going from display 400 to display 402 after determining an acceleration event has occurred.

In some embodiments, in response to receiving an acceleration event with a magnitude-to-time ratio that exceeds a preconfigured threshold, device 414 can be configured to continuously move through (e.g., scroll or jump around) options or menus (sometimes referred to as “free-scroll” when in the context of a list of options). The continuous movement can be stopped by device 414 in response to receiving one or more of a variety of possible inputs. For example, receiving an upward flick (e.g., upward vector 612 can be generated and) can cause the continuous movement to cease.

One skilled in the art will appreciate that device 414 can be configured to have highlight region 404 be moved in response to any type of acceleration vector(s), having any direction(s) and/or magnitude(s). For example, the invention is not limited to highlight region 404 moving down in response to downward vector 410, or up in response to upward vector 412. In some embodiments, highlight region 404 can move down in response to upward vector 412 and up in response to downward vector 410. As another example, acceleration navigation may only be enabled for navigating down a list, regardless of the acceleration vector's magnitude, direction (e.g., up, down, left, right and/or any combination there of) and/or type (e.g., flick, spin, tilt, slide, vibrate, etc.).

In addition to moving within a display, acceleration navigation can also be used to move within a menu hierarchy implemented on an electrical device. A menu hierarchy can include a series of displays that organize media and other features the electrical device enables the user to access.

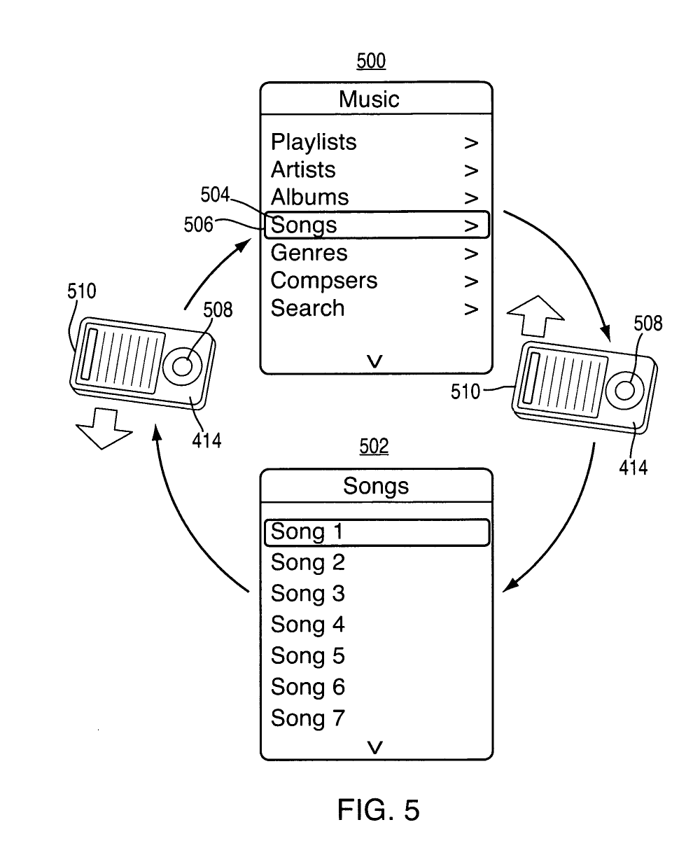

FIG. 5, for example, includes display 500 and display 502. A device can present display 500 in response to, for example, music option 406 being selected. The device can be, for example, device 414 or any other device that presented display 400 to the user. In this manner, display 500 is one level below display 402 in the device's menu hierarchy. As such, the options included in display 500 are subcategories of music option 406. The selection of music option 406 can occur in any number of ways. For example, the user may have used a user input component, such as a click wheel, one or more buttons, or multitouch screen to indicate a desire to select option 406.

FIG. 5 shows how an accelerometer can be used to select an option and advance to a lower level in the menu hierarchy. For example, while songs option 504 is highlighted by highlight region 506, if a user holds bottom portion 508 of device 414 and flicks top edge 510 to the right (relative to the display that is being presented), device 414 can present songs display 502. Songs display 502 is a level lower than display 500 in the menu hierarchy of device 414. Songs display 502 includes additional selectable options can be selected in any manner, such as device 414 determining that the top of device 414 has been flicked to the right.

One skilled in the art will appreciate that, depending on number, type(s) and placement of the accelerometer(s), any portion of the device can be flicked (or moved in any other fashion), relative to any other portion of the device or some absolute reference point. The device can be configured to respond in any suitable manner. For example, top edge 510 does not have to be the portion of the device that is flicked and the device can be configured to select an option in response to any portion and/or portions being moved in any manner and/or direction. As such, the invention can provide means for all types and kinds of acceleration navigation among options included in a display as well as all types and kinds of acceleration navigation among the displays of a menu hierarchy. In addition to visual displays, menu hierarchies can also include or be limited to audio, haptic and/or any other type of stimuli. Audio navigation of a media device's menu hierarchy is discussed in commonly assigned U.S. patent application Ser. No. 12/006,172, entitled “NON-VISUAL CONTROL OF MULTI-TOUCH DEVICE” (client docket no. P5665US1), which is hereby incorporated by reference in its entirety. In addition, media devices that provide haptic feedback to assist in navigation of displays are discussed in U.S. patent application Ser. No. 12/069,352, entitled “TOUCHSCREEN DISPLAY WITH LOCALIZED TACTILE FEEDBACK” (client docket no. P4994US1) and 61/009,625, entitled “TACTILE FEEDBACK IN AN ELECTRONIC DEVICE” (client docket no. P5345US1), which are hereby incorporated by reference in their entireties.

When, for example, a right flick (as shown in FIG. 5) causes device 414 to move down a level in its menu hierarchy, another movement, such as a left flick of top edge 510 (while bottom portion 508 is used as the pivot point), can cause device 414 to move up a level in its menu hierarchy.

In addition to the type and direction of the flick, the magnitude, number and/or temporal relation of the flick(s) can also be used to navigate options and menus provided by a portable or other device. FIG. 6 shows an example of how a number of down or up flicks, that cause downward vector 410 and upward vector 412 of FIG. 4, can cause the device to respond differently (than as discussed in connection with, e.g., FIG. 4) because the flicks occur within a preconfigured period of time. For example, electronic device 414 can be configured to increase the rate at which highlight region 604 scrolls through the list of songs, in response to more than one flick (or any other type of acceleration event) occurring within a preconfigured period of time (e.g., 2 seconds, 1 second, less than a second, or any other given period of time). As such, in response to detecting downward vectors 608 within one second of detecting downward vector 606 and detecting vector 610 within one second of vector 608, can cause device 414 to accelerate through the list and move, e.g., eight options down the list (instead of just three, one for each downward vector). Similarly, when upward vectors 612, 614 and 616 occur within the preconfigured period of time, highlight region can move back up the list to its initial position in a similar fashion.

The accelerated scrolling response, like any other response to acceleration vectors discussed herein, can be a dynamic, real-time (or near real-time) response based on any number of factors. The factors can be acceleration-related. For example, a greater magnitude of one or more of the acceleration vectors can cause device 414 to scroll through, e.g., list of options in an accelerated (faster or slower) manner.

In other embodiments, certain acceleration-related factors can be ignored for some or all acceleration vectors that are detected. For example, only the initial vector's magnitude (e.g., downward vector 606 or upward vector 612) can influence the acceleration navigation functionality of device 414.

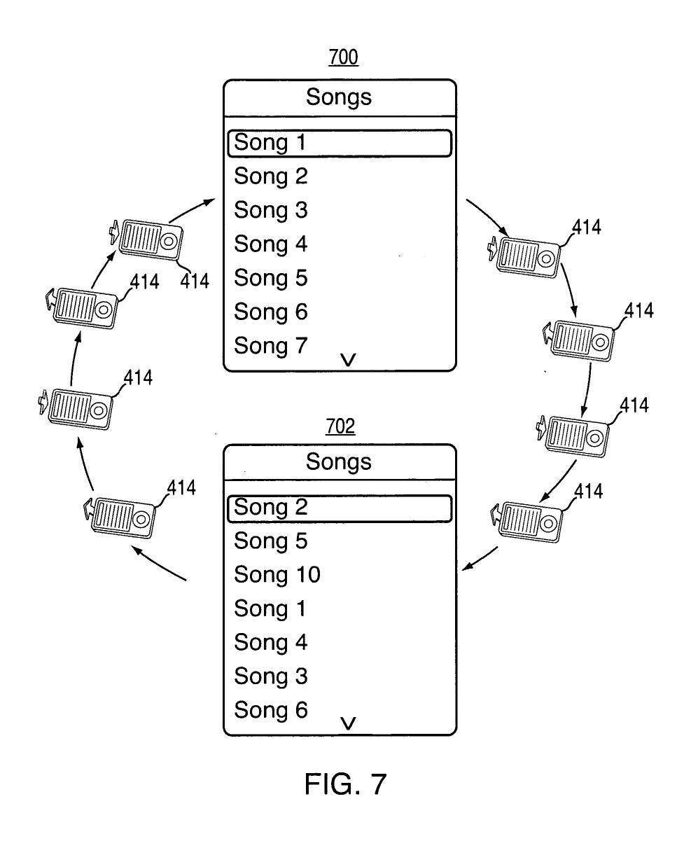

In some embodiments, the current mode of device 414 can influence device 414's response to one or more acceleration events. For example, FIG. 7 includes display 700, which shows a play list of songs. The play list is comprised of songs and an order in which the songs are played. The playback order of the songs represented in display 700 is from top to bottom. In other words, if “Song 1” is playing, “Song 2” can be played next, and so on down the list of display 700.

When device 414 receives one or more acceleration events while playing back a song (i.e., in playback mode), device 414 can respond differently than when the device 414 receives the same one or more acceleration events while in a different mode (e.g., telephone mode, Internet mode, search mode, menu browse mode, etc.). For example, a user can repetitively flick device 414 up and down, as the user would shake a mercury thermometer after taking one's temperature, while a song is being played back. In response to being flicked up and down two or more times while playing a song, device 414 can shuffle the play list, thereby rearranging the order of the songs to be played back (in some embodiments around the currently playing song). Device 414 can also present display 702 after the play list has been shuffled, and indicate the new play list's order of the same songs. One skilled in the art will appreciate that playback modes are not limited to songs, and that play lists can comprise any type of media or other data that can be presented to the user in an order that can be rearranged.

In some embodiments, a second set of repetitive down and up flicking of device 414 (like a thermometer) while in a playback mode, can cause additional shuffling of the playback order of the songs. In other embodiments, the second set of repetitive down and up flicking, can cause an unshuffling of the play list, thereby returning the order to the list as it is presented in display 700. In yet other embodiments, device 414 can be configured to shuffle when the initial flick (of the set of flicks) is down, and unshuffle when the initial flick (of the set of flicks) is up. One skilled in the art will also appreciate that any type of acceleration motion can be used to shuffle and/or unshuffle a play list.

In addition to the playback mode, the mode specific acceleration-based functionality and control of devices can be used to implement, activate and/or control any other function and/or feature provided by any electrical device, especially the devices that are handheld and easily manipulated by a user. For example, turning a device upside down while a telephone call is being received, can cause the call to go to voicemail, and turning the same device upside down in the same manner while a song is playing can cause the song to pause.

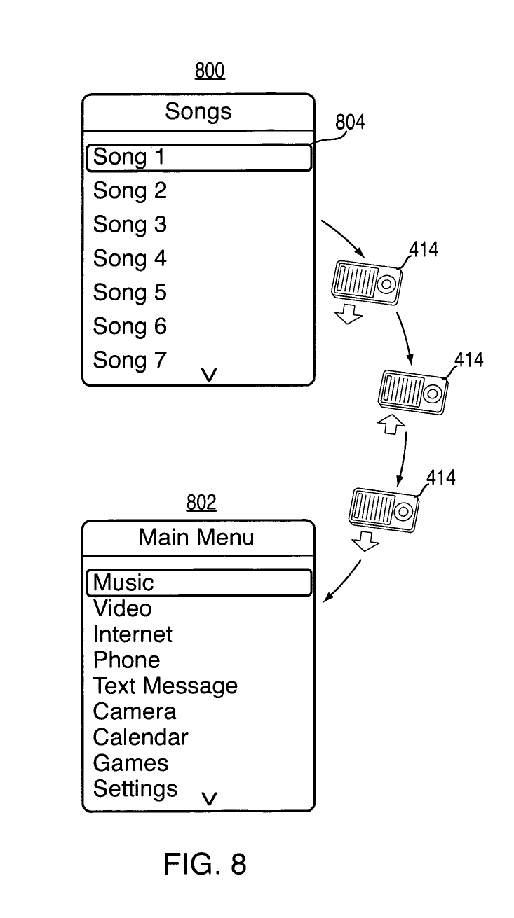

FIG. 8 shows another example of how acceleration navigation can be used to quickly and efficiently navigate a menu hierarchy. For example, the device can present the highest level menu, in response to a series of left flicks (or any other type and/or combination of types of flicks, such as two or more left and right flick combinations) being received while a lower level menu is being presented. Display 800, for example, can be three levels below display 802 in device 414's menu hierarchy. In response to device 414 being flicked left and right more than two times (within in a preconfigured period of time), device 414 can present display 802 to the user. One flick to the left can have a different result than being flicked left and right repeatedly. For example, device 414 can respond to one left flick as discussed in connection with FIG. 5 above. Similarly, one or more flicks to the right (while display 800 is being presented) can also have one or more different responses than a series of left and right flicks. For example, one flick to the right can start the playing the song that is associated with the option selected by highlight region 804, and two flicks to the right can stop the playing of the song.

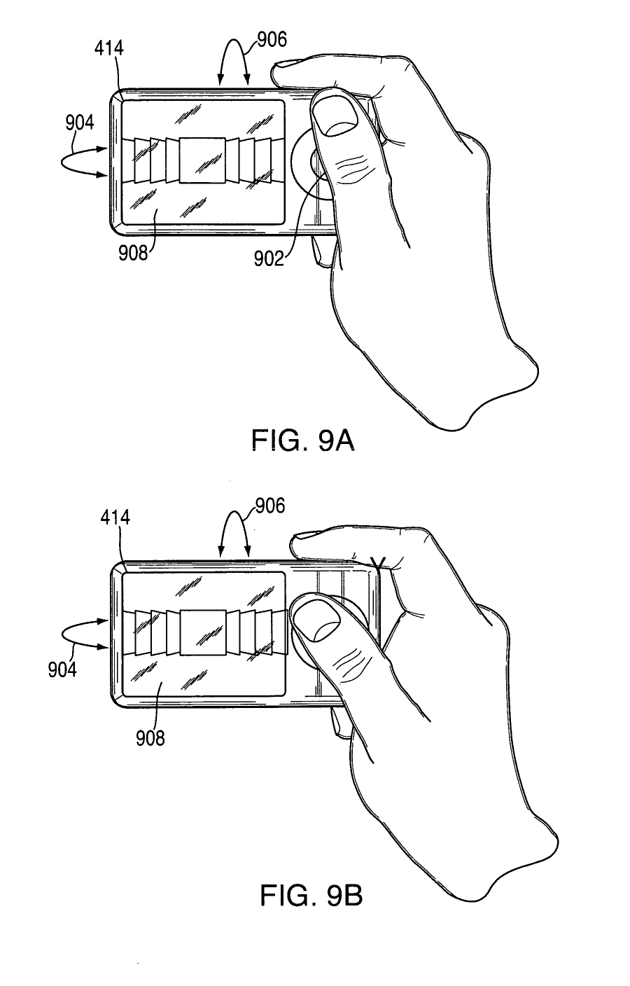

In some embodiments of the invention, an enabling event must occur before the acceleration navigation is activated by the device. FIG. 9A and FIG. 9B show one example of how an enabling event can occur, i.e., based on the output of a touch or proximity sensor.

The user's hand in FIG. 9 is holding device 414 and the user's right thumb is not touching or depressing button 902. Button 902 can serve as the acceleration navigation activation button as well as the selection button of a click wheel. To activate acceleration navigation, button 902 can detect a touch event, which can be different from a depression event. A depression event, for example, can require the user to apply more pressure, where as a touch event can occur in response to the user gently resting a finger on button 902. In some embodiments, a proximity sensor can also be integrated into button 902 and help or unilaterally activate acceleration navigation. In other words, device 414 will ignore and not response to being flicked up and down (as indicated by vector 904), spinned (as indicated by vectors 906), or accelerated in any other manner, unless acceleration navigation is activated. One skilled in the art will appreciate that any input component(s) and/or device(s) can be used as an acceleration navigation activation trigger.

In FIG. 9B, the user's thumb is placed on or near button 902 of device 414 and, in response, acceleration navigation of device 414 can be activated. In this manner, device 414 can allow a user to indicate that a flick or other acceleration-related gesture is forthcoming and meant for navigation, while still preventing random and/or unintended jarring of device 414 from initiating the scrolling or other acceleration-related features.

In some embodiments, acceleration navigation can be enabled only when an activation event is occurring. For example, in response to the user flicking device 414 fast and hard as shown in FIG. 9B, the options included in cover flow display 908 can enter into a free scroll (as discussed above). In response to the user's thumb being removed from button 902, the acceleration navigation enabling event can cease and the free scroll stop. This is sometimes referred to herein as a passive deactivation event. The user can then utilize more traditional scroll wheel navigation methods.

In other embodiments, the acceleration navigation can be enabled after an activation event and remain enabled until an active deactivation event, occurs. For example, when acceleration navigation is implemented on a multitouch device (such as device 200 of FIG. 2), a button (such as button 206) can function as an activation trigger similar to or the same as button 902. In response to the user flicking the multitouch device fast and hard after acceleration navigation has been activated, the options included in the display can free scroll. With an active deactivation trigger, the removal of the user's finger from the button may not cause the free scroll to stop. Rather, an active deactivation event may have to occur. An example of an active deactivation event for a multitouch device is a touch event on the multitouch display screen, which can stop the free scroll.

The detailed description thus far has, to avoid overcomplicating the discussion, generally focused on and referenced media displays, media files, media file systems, etc. that are related to audio signals. One skilled in the art will appreciate that the present invention is not limited to audio-related displays, data files, etc. In fact, the present invention can be used in connection with any type of data system (including, e.g., audio, video, still images, clip art, gaming, navigation, animation, other forms of moving images, any other type media and/or any combination thereof). Although the devices referenced herein can be any electrical device (as discussed above), additional technical challenges have been overcome to implement the invention, including the following methods, on a handheld device that has an integrated display screen.

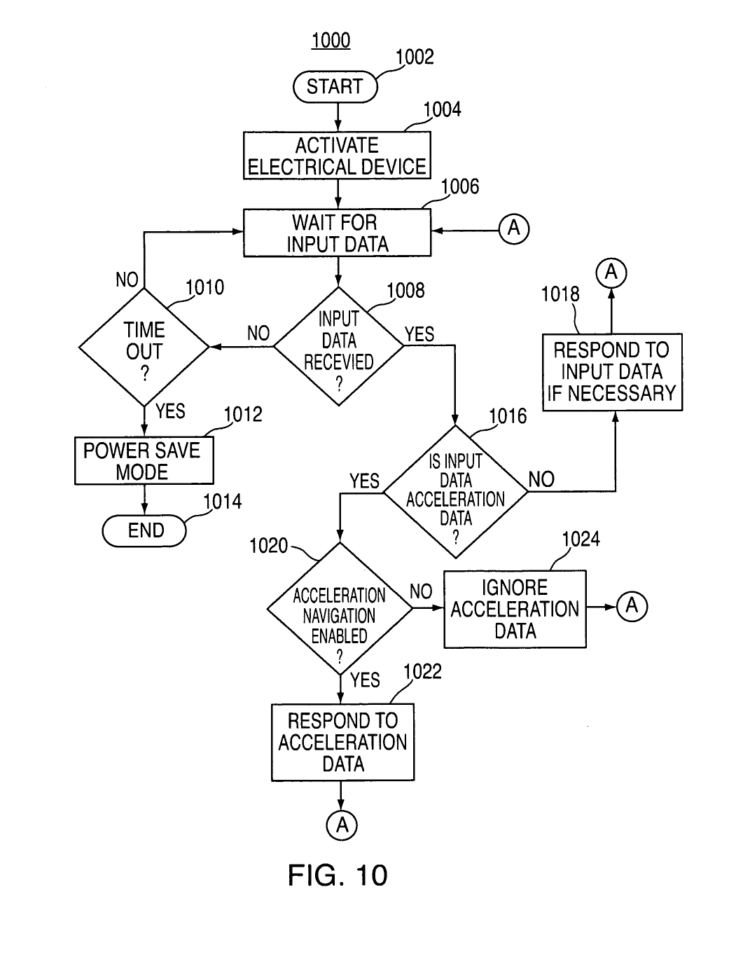

FIG. 10 shows process 1000, which is a method for providing acceleration navigation in accordance with some embodiments of the present invention. Process 1000 starts at step 1002.

At step 1004 the electrical device is activated (e.g., powered ON, exits stand-by mode, etc.) either automatically, in response to a user interaction or input, and/or in response to a command from a remote or host device. For example, the electrical device can be an iPod™ that is powered down until a user presses any button on its click wheel. As another example, the electrical device can be a cellular telephone or other wireless device that is activated in response to receiving a wireless signal (e.g., from a cellular telephone tower or other wireless terminal).

After the electrical device is activated, at step 1006 the circuitry of the electrical device can wait for input data from input circuitry or any other input source(s). The input source can include, for example, input circuitry that generates input data, and can be integrated into the electrical device, an accessory device, a peripheral device, or any other device. While the electrical device is waiting to receive input data, the electrical device can also provide output data to various output components, devices, etc. The output data can include executable commands. For example, the electrical device can provide output data to a display component that causes the display component to present one or more displays (such as the displays discussed above in connection with, e.g., FIGS. 4-9). As another example, the electrical device can play media or perform any other task. The output data initially presented can be generated from, for example, data stored in the electrical device's memory and/or storage or anywhere else.

At step 1008, the circuitry in the electrical device can determine whether or not input data has been received from any input source. Examples of input sources are discussed above and include, for example, a click wheel, a multitouch screen, an accelerometer, a microphone, a wireless receiver, any other component or device, and/or any other combination thereof. In response to determining that the electrical device has not received input data, process 1000 proceeds to step 1010.

At step 1010 the electrical device determines whether or not process 1000 has timed-out. To conserve power, the electrical device can be configured to automatically shut down, turn on a screen saver, enter a stand-by mode and/or perform any other function that will end process 1000. When, at step 1010, the electrical device determines that a predetermined amount of time has yet to elapse. Process 1000 returns to step 1006 while the electrical device continues to wait to receive input data. When the electrical device determines at step 1010 that it has timed-out, process 1000 proceeds to step 1012.

At step 1012, the electrical device enters a power save mode. The power save mode can include powering OFF the electrical device, turning on a screen saver, entering a stand-by mode and/or performing any other function that will conserve power. Process 1000 then ends at step 1014.

Returning to step 1008, the circuitry in the electrical device can also determine that its circuitry has received input data from one or more input sources. In response to this determination, process 1000 proceeds to step 1016.

At step 1016, the electrical device determines whether or not the input data is acceleration data. Acceleration data is a type of input data that is generated in response to one or more accelerometers sensing movement(s). In response to the electrical device determining that the input data does not include acceleration data, process 1000 proceeds to step 1018, at which the electrical device responds to the input data if necessary. Some types of input data may not illicit a response from and/or be ignored by the electrical device. In addition to the type of input data, whether or not a response is provided, can also be based on the current mode and/or state of the device. For example, scroll wheel input data, meant to increase the volume of audio playback, can be ignored when the audio is already being played back at the maximum volume.

The circuitry of the electrical device can also be configured to respond to many types of input data at step 1018. For example, input from a click wheel can cause a display to be presented, a highlight region to among options and/or audio to be emitted. As another example, an incoming signal from a cellular phone tower can cause the electrical device to emit an audible ringer and vibrate its vibration output component. After step 1018, process 1000 returns to step 1006 and waits for additional input data.

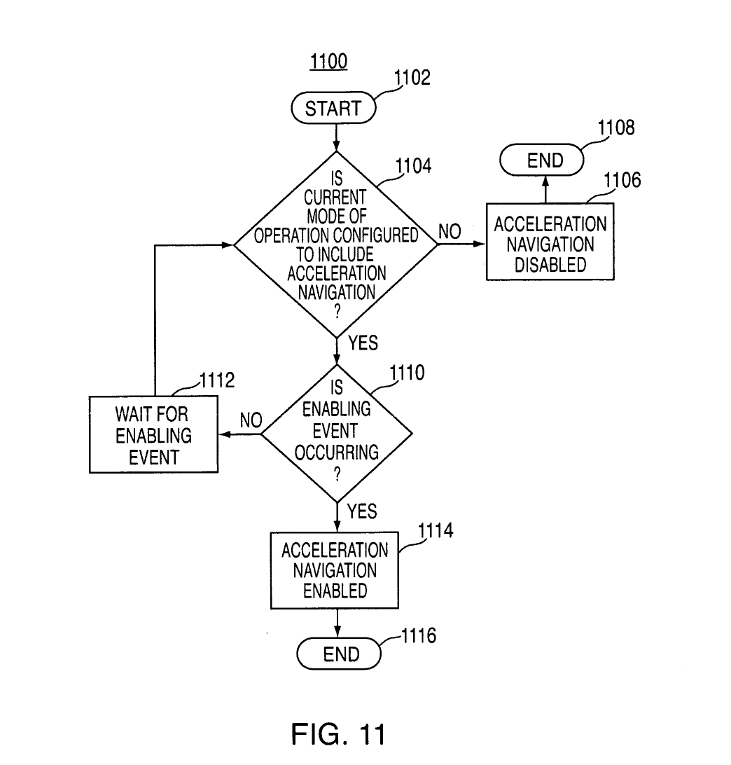

Returning to step 1016, in response to determining that the input data includes acceleration data, process 1000 advances to step 1020. At step 1020, the electrical device determines whether or not acceleration navigation is enabled. Process 1100 of FIG. 11 shows an exemplary method of determining whether or not acceleration navigation is enabled in accordance with some embodiments of the invention.

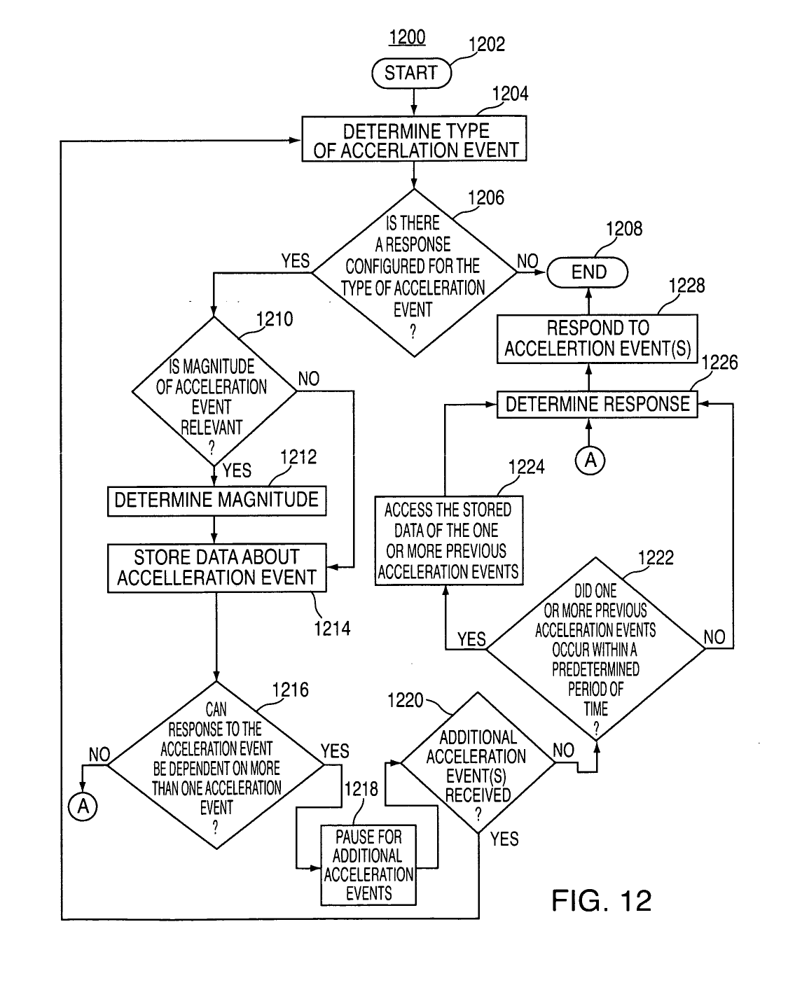

In response to determining that acceleration navigation is enabled, process 1000 advances to step 1022 and the electrical device responds to the acceleration data. Process 1200 of FIG. 12 shows an exemplary method of analyzing the acceleration data to provide the appropriate response (e.g., control the operating mode of the electrical device, move within the menu hierarchy, move among options included in a display, etc.) in accordance with some embodiments of the invention. Additional examples of how the electrical device can respond to different acceleration data signals (which, like any other signals discussed herein, are collections and/or series of data bits) are discussed above in connection with, e.g., FIGS. 4-9 and step 1018. After step 1022, process 1000 returns to step 1006 and waits for additional input data.

In response to determining that acceleration navigation is not enabled, process 1000 advances to step 1024 and the electrical device ignores the acceleration data. After step 1024, process 1000 returns to step 1006 and waits for additional input data.

FIG. 11 shows process 1100, which is an exemplary method of determining whether or not acceleration navigation is enabled in accordance with some embodiments of the invention. Process 1100 begins at step 1102.

Next is step 1104, at which the electrical device determines whether or not its circuitry is configured to provide acceleration navigation while in the current mode of operation. If not, process 1100 advances to step 1106. At step 1106, a determination is made that acceleration navigation is disabled and, as discussed above, the acceleration data is ignored. For example, electrical device may only be configured to provide a subset of the acceleration navigation features discussed above. Acceleration navigation can only be enabled while in a menu and/or browse mode (i.e., while navigating the menu hierarchy and/or browsing the options of a menu), for example, but disabled when in playback mode (or vice-versa). Process 1100 then ends at step 1108.

In response to the electrical device determining at step 1104 that its circuitry is configured to provide acceleration navigation while in the current mode of operation, process 1100 proceeds to step 1110. At step 1110, the electrical device determines whether or not an enabling event is occurring. Examples of enabling events are discussed in connection with, e.g., FIGS. 2, 9A and 9B above. In response to determining that an acceleration navigation enabling event is not occurring, process 1100 advances to step 1112 and waits for the enabling event to occur. Because the mode of operation can change while waiting for the enabling event, step 1104 follows step 1112.

Returning to step 1110, in response to the electrical device determining that an enabling event is occurring, the electrical device enables acceleration navigation at step 1114. Process 1100 ends at step 1116.

FIG. 12 shows process 1200, which is an exemplary method of analyzing the acceleration data to provide the appropriate response(s) in accordance with some embodiments of the present invention. Acceleration data can be generated by one or more accelerometers and correspond with a number of acceleration events. Each acceleration event can have a number of characteristics, which can each cause the electrical device to respond differently. Moreover, two or more acceleration events (e.g., two or more flicks) that do not occur within a (user or system) preconfigured period of time of each other, can illicit different responses from the electrical device. One skilled in the art will appreciate that process 1200 can be repeated for each acceleration event that does not occur within a predetermined period for time or if the device is not configured to perform, e.g., steps 1218-1224.

Process 1200 starts at step 1202 and proceeds to step 1204. The electrical device determines at step 1204 the type of acceleration event. For example, the type of acceleration event can be flick, tilt, slide spin, twist, etc. Examples of acceleration events are discussed above as well as in commonly assigned the '692 application (which is incorporated by reference above). In some embodiments the direction of the acceleration event can also be included in the type of acceleration event (e.g., right flick, up flick, down flick, sideways flick, etc.)

At step 1206 the electrical device determines whether or not its circuitry is configured to respond to the type of acceleration event. As described above, this determination can be dependent on the mode or state of the electrical device. In response to determining that its circuitry is not configured to respond to the type of acceleration event, process 1200 proceeds to step 1208 and ends without responding to the acceleration event. In response to determining that its circuitry is configured to respond to the type of acceleration event, process 1200 proceeds to step 1210 to further analyze the acceleration event.

At step 1210, the electrical device determines whether or not its circuitry is configured to respond differently based on the magnitude of the acceleration event. For example, a hard flick may illicit a different response than a soft flick. As another example, a violent shake of the device (a shake is different from a flick because the whole devices moves as opposed to only one side moving relative to another side) can illicit a different response than a gentle shake. In some embodiments, the device can also determine the time and/or the magnitude-to-time ratio. The time and magnitude-to-time ratio can be based on, for example, the number of clock cycles the acceleration event occurred for. One skilled in the art will appreciate that there is a difference between having a threshold value that needs to be exceeded to register an acceleration event and basing a response on the amount that a threshold value has been exceeded. Step 1212 is focused on the latter. (Exceeding an acceleration event threshold is included in the definition of an “acceleration event” as used herein, as such a flick or shake that is not hard enough to cause the accelerometer to generate acceleration data may not be considered an acceleration event.)

In response to determining that the magnitude of the acceleration event is relevant, the electrical device determines the magnitude of the acceleration event at step 1212. The acceleration data (including the type, magnitude, magnitude-to-time ratio, etc.) can be stored at step 1214 and be used to generate responses to subsequent (and/or previous) acceleration events. In response to determining that the magnitude of the acceleration event is irrelevant, process 1200 bypasses step 1212 and proceeds directly to step 1214 from step 1210.

Next is step 1216, at which the electrical device determines whether or not a response to the acceleration event can be dependent on a previous acceleration event. For example, in some modes of operation (such as some of those discussed above), a single flick can cause a different response than a plurality of flicks. Accordingly, the electrical device can pause for a period of time (e.g., 50 milliseconds) at step 1218, to allow another acceleration event to occur, before proceeding in process 1200. In this manner, the electrical device can account for and base any response on all the relevant acceleration events.

Next is step 1220, at which the electrical device determines whether or not one or more additional acceleration events were received during the waiting period at step 1218. When an additional acceleration event is received at step 1218 and detected at step 1220, process 1200 returns to step 1204. In some embodiments, the device is configured to execute steps 1204-1220 in less time than a device is likely to experience to rapid acceleration events (e.g., an up and down shake). In response to determining that no additional acceleration event occurred before the wait period of step 1218 expired, process 1200 proceeds to step 1220.

At step 1222 the electrical device determines whether or not one or more of acceleration events were received during any previous waiting periods (or at any other time) during a (user or system) preconfigured period of time. If there were one or more such events, and acceleration data for the events were stored by the electrical device, at step 1224 the electrical device can access the stored acceleration data associated with the event(s).

Step 1226 is next in process 1200. Step 1226 also follows step 1222 when there is not any previous acceleration events that occurred within the predetermined period of time. In addition, step 1226 follows step 1216 when the response to the acceleration event cannot be dependent on a previous acceleration event (because, e.g., the operating mode is not configured for a single response to multiple acceleration events).

At step 1226, the electrical device determines the appropriate response based on the type of acceleration event, the magnitude of the acceleration event and the number of acceleration events. At step 1228 the electrical device responds to the acceleration event. Some examples of responses are discussed above and can include navigating among a menu hierarchy, navigating among menu options, selecting menu options, rearranging menu options and play lists, controlling multimedia functionality (e.g., pausing, stopping and playing music and video), or any other functionality associated with the electrical device. Process 1200 then ends at step 1208.

The processes discussed above are intended to be exemplary and not limiting. One skilled in the art will appreciate that steps of the processes discussed herein may be omitted, modified, combined, and/or rearranged, and any additional steps may be performed without departing from the scope of the invention. Moreover, the above disclosure as a whole is also meant to be exemplary and not limiting. Only the claims that follow are meant to set bounds as to what the present invention includes.

What is claimed is:

1. A method of navigating a menu hierarchy of a handheld electrical device, comprising:
presenting a first display on an integrated display screen, wherein the first display is part of the menu hierarchy;
receiving acceleration data in response to an acceleration event; and
in response to the acceleration data, presenting a second display on the integrated display screen, wherein the second display is part of the menu hierarchy.

2. The method of claim 1, wherein presenting the second display further comprises:
presenting information associated with one or more types of multimedia the handheld electrical device is capable of playing back for the user, wherein the information is presented on the integrated display screen.

3. The method of claim 1, wherein presenting the first display further comprises:
presenting information associated with one or more songs stored on the handheld electrical device, wherein the information is presented on the integrated display screen.

4. The method of claim 1 further comprising:
analyzing the acceleration data, wherein analyzing the acceleration data includes determining a type of the acceleration event.

5. The method of claim 4, wherein determining the type of the acceleration event further comprises:
determining a prevailing direction of the acceleration event; and
determining a type movement that caused the acceleration event.

6. The method of claim 1 further comprising:
determining a magnitude of the acceleration event;
generating an acceleration vector, wherein the acceleration vector is based on the prevailing direction and the magnitude.

7. A handheld electrical device that plays media files and implements a menu hierarchy, comprising:
an integrated display screen;
at least one accelerometer that generates acceleration data in response to an acceleration event;
circuitry configured to implement the menu hierarchy, wherein implementing the menu hierarchy comprises:
generating a first display that is presented on the integrated display screen;
receiving the acceleration data;
in response to the acceleration data, generating a second display that is presented on the integrated display screen.

8. The handheld electrical device of claim 7, wherein:
the first display includes a list of options, wherein one of the options links to the second display.

9. The handheld electrical device of claim 7, wherein:
the acceleration data represents a user's desire to select the one of the options.

10. The handheld electrical device of claim 7, wherein:
the second display includes information associated with one or more types of multimedia the handheld electrical device is capable of playing back for the user.

11. The handheld electrical device of claim 7, wherein:
the first display includes information associated with one or more songs stored on the handheld electrical device.

12. The handheld electrical device of claim 11, wherein:
the information is clip art that corresponds with covers of one or more albums associated with the one or more songs.

13. The handheld electrical device of claim 7, wherein:
the circuitry is further configured to analyze the acceleration data to determine a type of the acceleration event.

14. A method of navigating a menu hierarchy of a handheld electrical device, comprising:
presenting a first display that includes a list of songs;
determining that the handheld device has been flicked up and down at least twice within a predetermined period of time;
in response to determining that the handheld device has been flicked up and down at least twice, generating a first set of flick data;
in response to the first set of flick data, generating a shuffled list of the songs; and
presenting a second display that includes the shuffled list of the songs.

15. The method of claim 14, wherein the presenting the first display occurs after:
presenting a previous display, wherein the previous display includes a songs option;
highlighting the songs option;
determining that the handheld electrical device has been flicked to the right;
in response to determining that the handheld electrical device has been flicked to the right, generating a previous set of flick data;
in response to the previous set of flick data, selecting the songs option; and
in response to the selection of the songs option, the presenting the first display.

16. A handheld electrical device that plays media files and implements a menu hierarchy, comprising:
an integrated display screen;
at least one accelerometer that generates flick data in response to the handheld device being flicked up and down at least twice within a predetermined period of time;
circuitry configured to implement the menu hierarchy, wherein implementing the menu hierarchy comprises:
generating a first display that is presented on the integrated display screen, wherein the first display includes a list of songs;
receiving the flick data from the at least one accelerometer;
in response to receiving the flick data, generating a shuffled list of the songs; and
generating a second display that includes the shuffled list of the songs, wherein the second display is presented on the integrated display screen.

17. The handheld electrical device of claim 16, wherein the circuitry is configured to generate the first display after the circuitry:
generates a previous display that includes a songs option;
highlights the songs option;
receives a previous set of flick data from the at least one accelerometer that indicates the handheld electrical device has been flicked to the right;
in response to receiving the previous set of flick data, selects the songs option; and
presents of the first display in response to selecting the songs option.

18. A method of navigating selectable options presented by a handheld device, comprising:
presenting a first display, wherein the first display includes selectable options;
highlighting a first option included in the selectable options;
determining that an acceleration event has occurred;
receiving acceleration data that corresponds with the acceleration event; and
in response to the receiving the acceleration data, presenting a second display, wherein presenting the second display includes highlighting a second option included in the selectable options.

19. The method of claim 18 further comprising:
in response to the acceleration data, scrolling through a number of the selectable options before highlighting the second option.

20. The method of claim 19 further comprising:
analyzing the acceleration data to determine a magnitude of the acceleration event; and
determining the number based on the magnitude.

21. The method of claim 20 further comprising:
analyzing the acceleration data to determine a magnitude-to-time ratio of the acceleration event; and
determining the number based on the magnitude-to-time ratio.

22. The method of claim 18, wherein the presenting the second display further comprises:
presenting the first option and the second option as adjacent options in a list.

23. The method of claim 18, wherein the presenting the second display further comprises:
presenting the first option and the second option as adjacent options in a cover flow display.

24. The method of claim 18 further comprising:
determining that the acceleration event was a flick.

25. The method of claim 18 further comprising:
determining that an additional acceleration event has occurred within a predetermined period of time;
receiving additional acceleration data that corresponds with the additional acceleration event; and
in response to the receiving the additional acceleration data, presenting a third display, wherein presenting the third display includes:
increasing the scrolling rate; and
highlighting a third option included in the selectable options.

26. A handheld electrical device that can navigate selectable options, comprising:
an integrated display screen;
at least one accelerometer that generates acceleration data in response to being physically moved;
circuitry configured to navigate the selectable options, wherein navigating the selectable options comprises:
presenting a first display on the integrated display screen, wherein the first display includes selectable options;
highlighting a first option included in the selectable options;
receiving the acceleration data from the at least one accelerometer;
in response to the receiving the acceleration data, presenting a second display, wherein:
a second option is highlighted; and
the second option is included in the selectable options.

27. The handheld electrical device of claim 26, wherein the circuitry is further configured to:
scroll through a number of selectable options before highlighting the second option in response to receiving the acceleration data.

28. The handheld electrical device of claim 27, wherein the circuitry is further configured to:
analyze the acceleration data to determine a magnitude of the acceleration event; and
determine the number based on the magnitude.

29. The handheld electrical device of claim 28, wherein the circuitry is further configured to:
analyze the acceleration data to determine a magnitude-to-time ratio of the acceleration event; and
determine the number based on the magnitude-to-time ratio.

30. The handheld electrical device of claim 26, wherein the circuitry is further configured to:
present the first option and the second option as adjacent options in a list.
